(19) United States
(12) Patent Application Publication
(10) Pub. No.: US 2024/0037015 A1
(43) Pub. Date: Feb. 1, 2024

(54) COMPUTER-IMPLEMENTED METHOD FOR VERIFYING AT LEAST ONE SOFTWARE COMPONENT OF AN AUTOMATED DRIVING FUNCTION

(71) Applicant: Robert Bosch GmbH, Stuttgart (DE)

(72) Inventors: Christian Heinzemann, Vellmar (DE); Lukas Koenig, Grossbottwar (DE)

(21) Appl. No.: 18/357,358

(22) Filed: Jul. 24, 2023

(30) Foreign Application Priority Data
Jul. 26, 2022 (DE) 10 2022 207 613.3

(51) Int. Cl. G06F 11/36; B60W 50/04

(52) U.S. Cl. CPC G06F 11/3608; B60W 50/045

(57) ABSTRACT

A computer-implemented method for verifying at least one software component of an automated driving function. The method includes the following steps: providing an environment model that limits the state space of the software component to be verified by way of predefinable boundary conditions, wherein the environment model is provided in the form of a native environment model program code; translating the native program code of the software component to be verified and the environment model program code, wherein a model checker representation limited by the boundary conditions of the environment model and intended for the software component to be verified is generated; and verifying the model checker representation using a model checking method.

### CROSS REFERENCE

The present application claims the benefit under 35 U.S.C. § 119 of German Patent Application DE 10 2022 207 613.3 filed on Jul. 26, 2022, which is expressly incorporated herein by reference in its entirety.

### FIELD

The present invention relates to a computer-implemented method for verifying a software component of an automated driving function. The present invention also relates to a software component of the automated driving function which has been verified using the provided method, and to a computer-implemented system for implementing an automated driving function, comprising at least one software component which has been verified using the provided method.

### BACKGROUND INFORMATION

Computer-implemented methods for verifying a software component, i.e., model checking methods, are described in Gerking, C., Dziwok, S., Heinzemann, C., Schafer, W., “Domain-Specific Model Checking for Cyber-Physical Systems,” Proceedings of the 12^{th} Workshop on Model-Driven Engineering, Verification and Validation (MoDeVVa 2015), Ottawa, September 2015; Kwiatkowska, M., Norman, G., Sproston, J., “Probabilistic Model Checking of the IEEE 802.11 Wireless Local Area Network Protocol,” Joint International Workshop on Process Algebra and Probabilistic Methods, Performance Modeling and Verification—Process Algebra and Probabilistic Methods: Performance Modeling and Verification, pages 169-187, 2002; and Konig, L., Pfeiffer-Bohnen, F., Schmeck, H., “Theoretische Informatik—ganz praktisch [Theoretical Information Technology—In Practice],” De Gruyter Studium, September 2016, chapter 2.4.

### SUMMARY

An object of the present invention is to provide an improved computer-implemented method for verifying a software component of an automated driving function and an improved system for implementing the driving function.

This object may be achieved by features of the present invention. Advantageous configurations and developments of the present invention are disclosed herein.

The present invention provides a computer-implemented method for verifying at least one software component of an automated driving function. According to an example embodiment of the present invention, the method comprising the following steps:
providing an environment model that limits the state space of the software component to be verified by way of predefinable boundary conditions, wherein the environment model is provided in the form of a native environment model program code,
translating the native program code of the software component to be verified and the environment model program code, wherein a model checker representation limited by the boundary conditions of the environment model and intended for the software component to be verified is generated, and
verifying the model checker representation using a model checking method.

The current state of the art in industrial development processes is testing whether driving functions, action planners, fusion algorithms, and other control modules have been correctly implemented. Methods such as simulation-based testing are often used in this case; however, they do not guarantee that errors are discovered. In contrast, model checking is a general verification method for software on the basis of automatic formal proof.

In this process, a program is translated into a model and checked for “correctness”. The term “correctness” is flexible depending on context, but is specified by precise mathematical formalisms (for example, temporal-logical formulas). Model checking analyzes all possible sequences in the program and outputs whether or not a given specification is fulfilled in all cases (and if not, under what circumstances it is not fulfilled). Examples of corresponding tools for model checking are
Spin (http://spinroot.com/spin/whatispin.html) and
NuSMV (http://nusmv.fbk.eu/).

In order to facilitate efficient model checking of existing program code (e.g., in C++, Python, etc.), it is necessary to translate the program code into a format or representation that the model checker can use. This step is generally performed manually by a developer. Approaches that automatically generate model checking problems are typically based on domain-specific modeling languages (DSML) and not on programming languages in C++ or the like.

According to an example embodiment of the present invention, it is particularly worthwhile to use the proposed method in safety-critical applications having large state spaces (for example having approx. 10²⁰ to 10³⁰ states) which can only be partially covered by testing alone. This relates in particular to driver assistance systems, automated driving functions, robots, aircraft controllers, autonomous ships, etc. This is because the environment model can advantageously limit the state space of the software component to be verified by way of predefinable boundary conditions and therefore contribute to the more efficient processing of the existing program code. In this case, the environment model can equally be provided in the form of a native environment model program code.

The translation process being presented here according to the present invention is particularly advantageously tailored for use in a production context for safety-critical systems (which generally have very large state spaces having the aforementioned number of states and are therefore complex to verify), i.e., with a focus on:
Complete provability of requirements, with requirements specifying, for example, requirements placed on the driving function of an automated vehicle, e.g., that the system has to deactivate if the vehicle leaves the freeway or that passing on the right is not allowed if the driving function is in the form of an adaptive cruise control (ACC) function, etc. (in contrast with partial proof, for which there are also model checking methods).
Applicability to a range of typical programming languages, such as C++, Python, Java, etc. Here, the proposed method can in particular be applied to existing program code.
Fully automated tooling for continuous integration.
Explainability, i.e., user-friendly outputs on all intermediate layers for debugging, etc.

In a further specific embodiment of the present invention, the native program code of the software component to be verified and the environment model program code are limited to a set of operations of the at least one programming language used that are defined as permissible.

Advantageously, by suitably limiting the native program code of the software component to be verified and the environment model, full automation can be obtained. For full automation, it is important, for example, to limit the C++/Python/etc. code to a set of operations of the programming language that are defined as permissible (in a simple variant, for example, by dispensing with all the loop/GoTo/recursion structures, or, with a positive formulation, by using logical operators, comparative operators, arithmetic operators, instructions for setting variables, so-called set instructions, e.g., for changing system variables, decision operations in the form of branches, e.g., if-else instructions, sequence operations, and a numerical range), which are then, in the translation process, converted into at least one finite automaton which forms the basis for generating the at least one model checker representation for the analysis by way of model checking methods.

In a further specific embodiment of the present invention, the environment model describes boundary conditions for starting states of the software component to be verified and/or boundary conditions for changes in the state of the software component to be verified. By the environment model describing boundary conditions for starting states of the software component to be verified and/or boundary conditions for changes in the state of the software component to be verified, it is possible to limit the state space of the software component to be verified. This state space can, for example, be limited by restricting the content of the variables to what is possible in the real world. In the context of automated driving, this could relate to statements regarding physics and the behavior of other drivers, for example. Without an environment model, the model checker would check invalid sequences in which, for example, a vehicle “jumps” from one lane to the other or from being in front to being behind. This both slows down the process and results in “false positives,” i.e., in unrealistically strict statements regarding errors (for example, the above-mentioned “jump” could generate cut-ins which are not even physically possible, and this could result in the safety distance not being maintained, which a driving algorithm could not prevent). In this way, reliability and safety can thus advantageously be improved.

In a further specific embodiment of the present invention, during the translation, the native program code of the software component to be verified and the environment model program code are transferred into the structure of a common finite automaton. The model checker representation limited by the boundary conditions of the environment model and intended for the software component to be verified is generated on the basis of the common finite automaton. The proposed method can advantageously be adjusted flexibly to the existing native program code or to the respective safety-critical applications and provides clear, readily understood, and biunique structures for the model checking method.

In a further specific embodiment of the present invention, at least in a first step, during the translation of the native program code of the software component to be verified and the environment model program code, at least one intermediate representation of the software component to be verified and/or of the environment model is generated which has the structure of a finite automaton (FA segments), in which at least part of the native program code (code segment) is embedded. This advantageously facilitates fully automatic model checking for regular programming languages. The proposed method is also advantageously programming language-agnostic, i.e., at least all the conventional procedural, object-oriented, and functional programming languages are suitable for said method. Therefore, the proposed method provides greater flexibility than conventional prior-art methods. The model checker representation is also formally unique, in contrast with conventional methods based on test scenarios.

In a further specific embodiment of the present invention, in at least one further step, during the translation of the native program code of the software component to be verified and the environment model program code, the at least one code segment of the at least one intermediate representation is converted into FA segments. This advantageously facilitates fully automatic model checking for regular programming languages. Therefore, the proposed method provides greater flexibility than conventional prior-art methods. The model checker representation is also formally unique, in contrast with conventional methods based on test scenarios.

In a further specific embodiment of the present invention, at least in a first step, the program code of the software component to be verified and the environment model program code are each transferred, independently of one another, into a separate intermediate representation having the structure of a finite automaton. In at least one further step, these two intermediate representations are transferred into a common finite automaton, on the basis of which the model checker representation for the software component to be verified is generated. The proposed method can advantageously be adjusted flexibly to the existing native program code or to the respective safety-critical application and provides clear, readily understood, and biunique structures for the model checking method.

In a further specific embodiment of the present invention, the software component of the automated driving function forms an adaptive cruise control (ACC) function for an automated vehicle. In this case, the ACC function includes distance control, lane keeping assist, and optionally other sub-functions. The proposed method can advantageously be used in the design period for the system (accessibility to the runtime) in order to, for example, check the correctness of the driving function, e.g., the proposed ACC function, an action planner, or another control module in an automated vehicle.

In this case, the method is technically advantageously not limited to the context of automated driving or to a driving function of this kind, but rather can also be applied in other software modules, provided that they can be defined as finite automata. It is particularly worthwhile to use said method in safety-critical applications having large state spaces which can only be partially covered by testing alone. This relates in particular to driver assistance systems, automated driving functions, robots, aircraft controllers, autonomous ships, etc. The proposed method can advantageously replace parts of the testing process and thus contribute to savings in terms of cost and time.

In a further specific embodiment of the present invention, the model checking method is performed using the NuSMV tool on the basis of computation tree logic (CTL) or linear temporal logic (LTL). It is particularly advantageous here that the present invention can be used universally and flexibly and is in particular compatible with commonplace tools.

In addition, a software component of an automated driving function which has been verified using the above-mentioned method is provided according to the present invention. This in particular provides a high level of flexibility and simple practicability in the development period.

Furthermore, according to an example embodiment of the present invention, a computer-implemented system is provided for implementing an automated driving function, comprising the at least one above-mentioned software component which has been verified using the proposed method.

The advantageous configurations and developments of the present invention that are disclosed herein can be used in isolation but also in any combination with one another, except, for example, where there are distinct dependency references or incompatible alternatives.

The above-described properties, features, and advantages of the present invention and the manner in which they are achieved become clearer and more readily comprehensible in conjunction with the following description of exemplary embodiments, which are explained in greater detail in conjunction with the schematic figures.

### BRIEF DESCRIPTION OF THE DRAWINGS

FIG. 1 is a schematic overview of a flow chart for contextualizing the principle of the present invention.

FIG. 2 is a schematic representation of a method for verifying a software component of an automated driving function according to a first specific embodiment of the present invention, based on the principle in FIG. 1.

FIG. 3 is a schematic representation of a method for verifying a software component of an automated driving function according to a second specific embodiment of the present invention, based on the principle in FIG. 1.

FIG. 4 is a schematic representation of a method for verifying a software component of an automated driving function according to a third specific embodiment of the present invention, based on the principle in FIG. 1.

### DETAILED DESCRIPTION OF EXAMPLE EMBODIMENTS

It should be noted that the figures are merely schematic in nature and are not to scale. As such, components and elements shown in the figures may be shown much larger or smaller to aid understanding. Furthermore, it should be noted that the reference signs in the figures have been selected to be the same when they relate to identical elements and/or components.

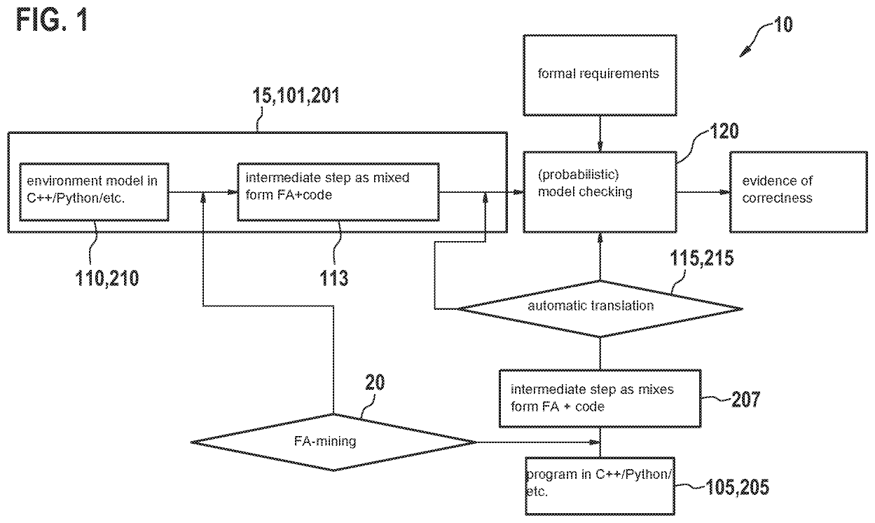

FIG. 1 is a schematic overview of a flow chart 10 for organizing the principle 15 of the present invention. At least one software component of an automated driving function is intended to be verified using a model checking method. For example, the automated driving function can form an adaptive cruise control (ACC) function for an automated vehicle. For this purpose, the present application proposes providing an environment model 101, 201 (principle 15 of the present invention, indicated by the border line).

The above-mentioned environment model is understood to be a limitation of the system behavior to be checked to what is “physically possible,” “realistic,” or “sufficiently approximate,” in order to facilitate a productive analysis. This means that the environment model includes a description of:
the physics (e.g., traffic simulation in the context of an automated driving function),
the behavior of other drivers (intent detection), and
the abstraction of reality (for example by quantization, e.g., with the introduction of a geometric grid to approximate the actually continuous positions of the vehicles).

In this case, the first two points are geared in particular toward realism, in order to prevent “false positives” (in the sense of reported errors which are not really errors at all), and the third point is geared toward facilitating an efficient simulation by reducing the size of the state space. This is because, without an environment model, the model checker would potentially check invalid sequences in which, for example, a vehicle “jumps” from one lane to the other or from being in front to being behind. This both slows down the model checking process and results in “false positives,” i.e., in unrealistically strict statements regarding errors (for example, the above-mentioned “jump” could generate cut-ins which are not even physically possible, and this could result in the safety distance not being maintained, which a driving algorithm or automated driving function could not prevent).

In this case, the environment model is provided in the form of a native environment model program code 110, 210, and, as already mentioned, is used to limit the state space of the software component to be verified by way of predefinable boundary conditions for starting states and/or boundary conditions for changes in the state of the software component to be verified. Particularly safety-critical applications having large state spaces (for example having approx. 10²⁰ to 10³⁰ states) which can only be partially covered by testing alone advantageously benefit from the proposed principle 15 of the present invention, namely the provision of an environment model 101, 201. Safety-critical applications may be, e.g., driver assistance systems, highly automated driving functions, robots, aircraft controllers, autonomous ships, etc.

The environment model 110, 210 and the software component 105, 205 to be verified, which is likewise specified in the form of a native program code, are first pre-processed 20. This means the native program codes 105, 205, 110, 210 are each translated 115, 215 fully automatically into an intermediate representation 207, 213 which has the structure of a finite automaton (FA segments), in which at least part of the native program code (code segment) is embedded. The process can be referred to as “mining,” for example.

The two intermediate representations 207, 213 are lastly translated into a model checker representation, which, e.g., has a pure FA form (in particular, for this purpose, the at least one code segment is converted into FA segments) and can be processed by a model checker. The model checking 120 is carried out on the basis of the model checker representation and, as shown, is used for evidence of correctness.

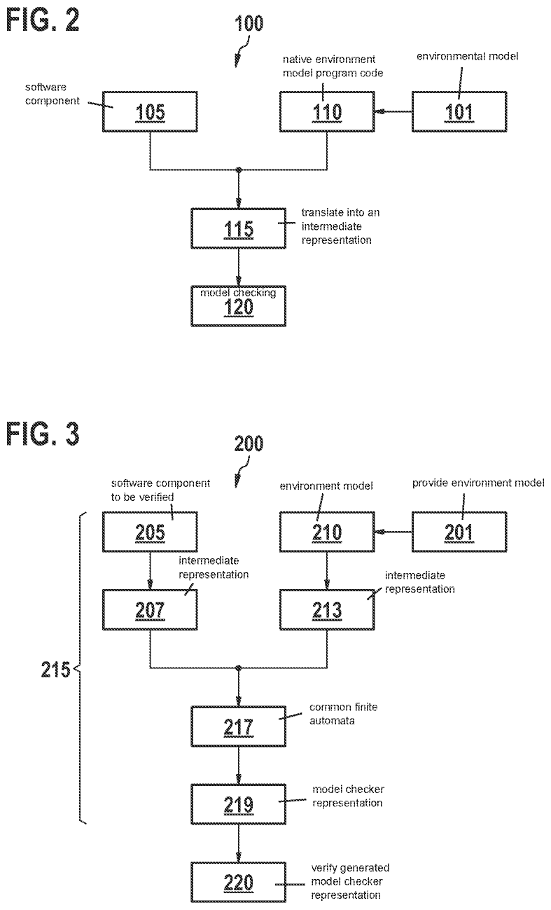

FIG. 2 is a schematic representation of a computer-implemented method 100 for verifying at least one software component of an automated driving function according to a first specific embodiment. The software component, to be verified, of an automated driving function can, e.g., form an ACC function, as mentioned above. In this case, the ACC function can include distance control, lane keeping, and optionally other sub-functions. Here, the method 100 is based on the principle 15 shown in FIG. 1. A first step 101 comprises providing an environment model 110 in FIG. 2 that fulfills the above-mentioned purpose, namely that limits the state space of the software component to be verified by way of predefinable boundary conditions. In this case, the environment model is, for example, described as native environment model program code 110 (e.g., in the programming language C++, Python, etc. that is being used), wherein the native program code is limited to a set of operations of the programming language used that are defined as permissible.

For example, this can be achieved by dispensing with all the loop/GoTo/recursion structures, or, with a positive formulation, by using logical operators, comparative operators, arithmetic operators, instructions for setting variables, so-called set instructions, e.g., for changing variables or system variables, decision operations in the form of branches, e.g., if-else instructions, sequence operations, and a numerical range.

The software component to be verified by way of model checking is likewise described by native program code 105. This is preferably likewise limited to the above-mentioned set of operations that are defined as permissible. The native program code of the software component 105 to be verified and the native environment model program code 110 are translated in a second step 115. In the translation process, in the second step 115, a model checker representation limited by the boundary conditions of the environment model is generated. This can, for example, take place such that, during the translation, the native program code of the software component 105 to be verified and the native environment model program code 110 are transferred into the structure of a common finite automaton (FA). The model checker representation limited by the boundary conditions of the environment model is lastly generated on the basis of the common FA. In a third step 120, the model checker representation is verified by way of a model checking method on the basis of the model checker representation generated in the preceding step. For example, the model checking method can be performed using the NuSMV tool on the basis of computation tree logic (CTL) or linear temporal logic (LTL).

In an alternative configuration, the second step 115 in FIG. 2 can include a first and a second sub-step (not shown). In a first sub-step, during the translation of the native program code of the software component 105 to be verified and the environment model 110, at least one intermediate representation 207, 213 of the software component to be verified and/or of the environment model is generated, similarly to the representation in FIG. 1. The at least one intermediate representation 207, 213 in each case has the structure of a finite automaton (FA segments), in which at least part of the native program code (code segment) of the software component to be verified and/or of the environment model is embedded.

In a second sub-step, during the translation of the native program code of the software component 105 to be verified and the environment model 110, the at least one code segment of the at least one intermediate representation 207, 213 is converted into FA segments. The first and the second sub-step can likewise lead to, during the translation, the native program code of the software component 105 and the environment model 110 being transferred into the structure of a common finite automaton, and to the model checker representation, which is limited by the boundary conditions of the environment model 110, being generated on the basis of precisely this common finite automaton.

FIG. 3 is a schematic representation of a method 200 for verifying a software component of an automated driving function according to a second specific embodiment. In a first step 201 of the method 200 in FIG. 3, an environment model 210 is provided which is described by native environment model program code, similarly to the first step 101 in FIG. 2. The software component to be verified by way of model checking is also described by native program code, as has been explained in conjunction with FIG. 1. Therefore, in this respect, reference is made to the above explanation.

In contrast with the method 100 in FIG. 2, in the method 200 in FIG. 3, in a second step 215, during the translation of the native program code, the program codes of the software component 205 to be verified and the environment model program code 210 are each transferred, independently of one another, into a separate intermediate representation 207, 213 having the structure of a finite automaton, which can comprise code segments and FA segments (the intermediate representation of the software component to be verified is, for example, denoted by reference sign 207 and the intermediate representation of the environment model program code is denoted by reference sign 213). This transfer can be carried out as explained in conjunction with FIG. 1 (“mining”), for example.

The two intermediate representations 207, 213 are lastly transferred into a common finite automaton 217, on the basis of which the model checker representation 219 for the software component to be verified is generated. A third step 220 in FIG. 3 is configured similarly to the third step 120 in FIG. 2, namely verifying the generated model checker representation 219 by way of model checking.

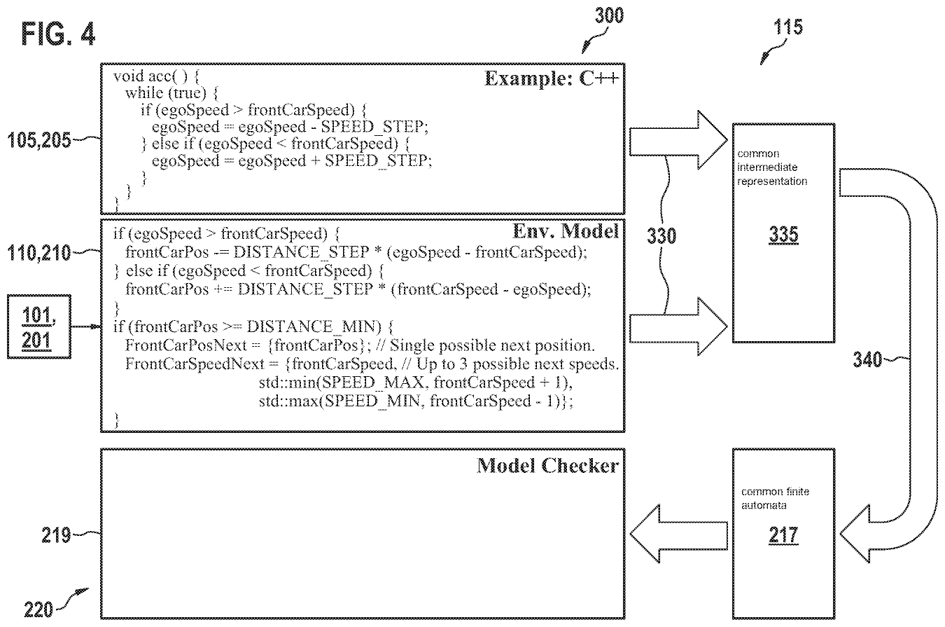

FIG. 4 is a schematic representation of a method 300 for verifying a software component of an automated driving function according to a third specific embodiment. The first step, i.e., providing 101, 201 the environment model in the form of a native environment model program code 110, 210, is analogous to the first steps in FIGS. 2 and 3 in this case. In contrast with the preceding FIGS. 2 and 3, in FIG. 4, native program code examples for the software component to be verified (“Example: C++,” 110, 210) and the environment model (“Env. Model,” 105, 205) are provided. These code examples, however, should not be understood as limiting the programming language used, since the proposed method, as mentioned above, is programming language-agnostic.

For example, the software component to be verified can form an adaptive cruise control (ACC) function for an automated vehicle and be implemented as follows as native C++ program code 105, 205:

void acc( ) {
while (true) {
if (egoSpeed > frontCarSpeed) {
egoSpeed = egoSpeed − SPEED_STEP;
} else if (egoSpeed < frontCarSpeed) {
egoSpeed = egoSpeed + SPEED_STEP;
}
}
}

In this code, “egoSpeed” can be a variable or system variable which represents the ego speed of the automated vehicle and “frontCarSpeed” can be a variable or system variable which represents the speed of another vehicle located in the environment of the automated vehicle, i.e., for example, a vehicle traveling in front, and “SPEED STEP” can describe a speed step. At this juncture, it is already apparent that the speed of the other vehicle located in the environment of the automated vehicle (“frontCarSpeed”) is not known without using an environment model, and therefore there is also no change in said speed or said variables/system variables, but rather only in the speed (“egoSpeed”) of the automated vehicle.

An associated environment model 110, 210 which has been specially adjusted to the above ACC driving function as the software component 105, 205 to be verified can, for example, look as follows in C++ code:

if (egoSpeed > frontCarSpeed) {
frontCarPos −= DISTANCE_STEP * (egoSpeed − frontCarSpeed) ;
} else if (egoSpeed < frontCarSpeed) {
frontCarPos += DISTANCE_STEP * ( frontCarSpeed − egoSpeed) ;
}
if (frontCarPos >= DISTANCE_MIN) {
FrontCarPosNext = {frontCarPos}; / / Single possible next position.
FrontCarSpeedNext = { frontCarSpeed, / / Up to 3 possible next speeds.
std::min(SPEED_MAX, frontCarSpeed + 1) ,
std::max(SPEED_MIN, frontCarSpeed − 1) } ;
} // ″else″ no next states at all.

The environment model 110, 210 can, for example, limit the state space of the variables/system variables “egoSpeed” and “frontCarSpeed” by way of predefinable boundary conditions, with the predefinable boundary conditions being able to represent, in said example, the consideration of the position of the vehicle traveling in front (“frontCarPos”) and the use of an accuracy regulation (see above: quantization by the introduction of a geometric grid, or the like) of the situation in question via “DISTANCE_STEP”. Said boundary conditions can relate both to the starting states of the variables/system variables and/or to the changes in state of said variables/system variables. In this case, a starting state can also be understood to be a limited value range of a variable/system variable, for example.

The environment model 110, 210 thus facilitates, inter alia, a calculation of the positions/speeds/etc. of other vehicles in the environment of the automated vehicle, with a set of possibilities being able to be (non-deterministically) specified if an aspect is unclear at the current moment, for example whether another vehicle will accelerate (“std::min(SPEED_MAX, frontCarSpeed+1)”) or brake (“std::max(SPEED_MIN, frontCarSpeed−1)”) in the next step. In particular, the above environment model 110, 210, in combination with the ACC function indicated above as the software component 105, 205 to be verified, can be used to better verify whether, for example, it is possible for the vehicle to be driven without an accident occurring by considering the position of a vehicle traveling in front. Therefore, the environment model 110, 210 not only advantageously improves the performance of a model checking method and the associated computing resources by suitably limiting the state space of the software component to be verified, but also makes a significant contribution to the safety of an automated vehicle comprising the software component 105, 205, to be verified, of the automated driving function.

In the example shown in FIG. 4, a second step 115, i.e., the translation of the two above-mentioned program codes of the ACC function 105, 205 and the environment model 110, 210, similarly to the alternative explained in conjunction with the second step 115 in FIG. 2, contains a first and a second sub-step 330, 340. In this case, the first sub-step 330 can, for example, involve generating a common intermediate representation 335 from the program codes of the ACC function 105, 205 and the environment model 110, 210. Here, the individual or common intermediate representation 335 can have the structure of a finite automaton, which still comprises at least one native program code segment of the ACC function 105, 205 and/or the environment model 110, 210. In this case, the transfer can take place as explained above, for example. The second sub-step 340 can follow the first sub-step 330 and involve the conversion of the at least one native program code, still embedded in the FA structure, of the intermediate representation 335 into FA segments. From the second sub-step 340, a pure finite automaton 217 can be produced, for example. Provided that they include a decision operation (branch in the form of an if/else instruction, for example) and/or a sequence operation (instructions for setting/changing variables/system variables in the form of set instructions, for example) and occur within one state of the FA segment of the intermediate representation, the code segments still embedded in the intermediate representation 335 can be converted into a partial automaton, for example, with the partial automaton then comprising at least two states which the finite automaton assumes either in a mandatory or conditional manner when executing the decision operation. As an alternative to the conversion into a partial automaton, the sequence operations, i.e., the set instructions, can each be assigned a program counter. The program counter is retained during the translation into the model checker representation. In this way, the code segments that still remain can, for example, be easily converted into pure FA segments and the common finite automaton 217 can be generated.

On the basis of the finite automaton 217, the model checker representation 219 is generated, which is lastly verified by way of a model checking method. For example, the model checking method can be performed using the NuSMV tool on the basis of computation tree logic (CTL) or linear temporal logic (LTL), as also explained above.

Advantageously, the use of the environment model 110, 210 can contribute to limiting the state transitions in the FA or in the intermediate form of the FA in order to generate a realistic and efficient simulation. For example, the result of the environment model 110, 210 in FIG. 4 is that the speed of the vehicle traveling in front can only ever change by at most +/−1 from one point in time to the next (without a limitation, the model checker would assume that the speed can always change by any value).

It goes without saying that the features explained in conjunction with FIG. 4 in relation to the ACC function as the software component 105, 205 to be verified, the environment model 110, 210, and the individual steps and sub-steps and the resulting structures/representations are also applicable to FIGS. 1 to 3, which are explained above.

Lastly, it is expressly noted that, in addition to the above-described method 100, 200, 300 for verifying a software component of an automated driving function, the present invention also relates to a software component verified in accordance with the present invention and to a computer-implemented system for implementing the automated driving function, which comprises at least one software component verified in accordance with the present invention.

The present invention has been described in detail on the basis of preferred exemplary embodiments. Instead of the exemplary embodiments described, further exemplary embodiments which can include further modifications to or combinations of described features are possible. For this reason, the present invention is not limited to the disclosed examples since a person skilled in the art may derive other variations therefrom without departing from the scope of the present invention.

What is claimed is:

1. A computer-implemented method for verifying at least one software component of an automated driving function, the method comprising the following steps:
providing an environment model that limits a state space of the software component to be verified by way of predefinable boundary conditions, wherein the environment model is provided in the form of a native environment model program code;
translating native program code of the software component to be verified and the environment model program, wherein a model checker representation limited by the boundary conditions of the environment model and intended for the software component to be verified is generated; and
verifying the model checker representation using a model checking method.

2. The method as recited in claim 1, wherein the native program code of the software component to be verified and the environment model program code are limited to a set of operations of at least one programming language used that are defined as permissible.

3. The method as recited in claim 1, wherein the environment model describes boundary conditions for starting states of the software component to be verified and/or boundary conditions for changes in a state of the software component to be verified.

4. The method as recited in claim 1, wherein, during the translation, the native program code of the software component to be verified and the environment model program code are transferred into the structure of a common finite automaton, and wherein the model checker representation limited by the boundary conditions of the environment model and intended for the software component to be verified is generated on the basis of the common finite automaton.

5. The method as recited in claim 1, wherein, at least in a first step, during the translation of the native program code of the software component to be verified and the environment model program code, at least one intermediate representation of the software component to be verified and/or of the environment model is generated which has a structure of a finite automaton (FA segments), in which at least part of the native program code (code segment) is embedded.

6. The method as recited in claim 5, wherein, in at least one further step, during the translation of the native program code of the software component to be verified and the environment model program code, the at least one code segment of the at least one intermediate representation is converted into FA segments.

7. The method as recited in claim 5, wherein, at least in a first step, the program code of the software component to be verified and the environment model program code are each transferred, independently of one another, into a separate intermediate representation having a structure of a finite automaton, and wherein, in at least one further step, the intermediate representations are transferred into a common finite automaton, based on which the model checker representation for the software component to be verified is generated.

8. The method as recited in claim 1, wherein the software component of the automated driving function forms an adaptive cruise control function for an automated vehicle.

9. The method as recited in claim 1, wherein the model checking method is performed using a NuSMV tool based on of computation tree logic or linear temporal logic.

10. A software component of an automated driving function which has been verified, the software component being verified by performing the following steps:
providing an environment model that limits a state space of the software component to be verified by way of predefinable boundary conditions, wherein the environment model is provided in the form of a native environment model program code;
translating native program code of the software component to be verified and the environment model program, wherein a model checker representation limited by the boundary conditions of the environment model and intended for the software component to be verified is generated; and
verifying the model checker representation using a model checking method.

11. A computer-implemented system for implementing an automated driving function, comprising:
at least one software component verified by performing the following steps:
providing an environment model that limits a state space of the software component to be verified by way of predefinable boundary conditions, wherein the environment model is provided in the form of a native environment model program code;
translating native program code of the software component to be verified and the environment model program, wherein a model checker representation limited by the boundary conditions of the environment model and intended for the software component to be verified is generated; and
verifying the model checker representation using a model checking method.
